(19) United States
(12) Patent Application Publication
(10) Pub. No.: US 2008/0105725 A1
(43) Pub. Date: May 8, 2008

(54) Striking Machine

(76) Inventors: Junichi Tamura, Tokyo (JP); Masafumi Satsuka, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/791,474

(22) PCT Filed: Nov. 24, 2005
(86) PCT No.: PCT/JP05/21559

§ 371 Date: May 24, 2007

(30) Foreign Application Priority Data
Nov. 26, 2004 (JP) 2004-341603

(51) Int. Cl. B25C 1/00

(52) U.S. Cl. 227/119

(57) ABSTRACT

A contact member 10 is provided with engaging claws 23, 24 held by a nose portion 4 and directed in a direction of a front end of the contact member. A vertical guide 12 is provided with a pair of chuck members 13 which are pivotably arranged opposedly by interposing a strike axis line such that a screw or a nail is guided along a strike axis line and in which front end portions 22 are urged to pivot by elastic means in directions of being proximate to each other. The vertical guide 12 is slidably arranged along a direction of striking a screw or a nail relative to the nose portion 4. The vertical guide 12 is elastically urged such that a front end portion of the vertical guide 12 is normally projected further from the engaging claws 23, 24 of the contact member 10.

### TECHNICAL FIELD

The present invention relates to a striking machine of a screw or a nail for striking out a screw or a nail struck out from a nose portion of a screw fastener or a nailing machine along an axis line direction of the nose portion, introducing the screw or the nail into a hole previously formed at a struck member, and striking the screw or the nail into the hole.

### BACKGROUND ART

There are a screw fastener for screwing a screw by a driver bit driven to rotate by an electric motor, an air motor or the like, and a nailing machine for striking a nail by a driver linearly driven by compressed air or the like. (Hereinafter, a screw fastener, a nailing machine or the like is referred to as a striking machine.) Further, there is a striking machine including a vertical guide having a pair of chuck members axially held openably/closably in a left and right direction or in a front and rear direction by interposing a strike axis line so as to guide a front end portion and an axis portion of a screw or a nail to be struck along the strike axis line. The screw or the nail can be struck substantially orthogonally to a face of a struck member by introducing the front end portion and the axis line of the screw or the nail struck out from a screw fastener or a nailing machine to the struck member by the vertical guide.

JP-Y-06-047669 discloses a striking machine including a contact member arranged to be projected in a direction of a front end of a strike portion slidably along a direction of striking a screw or a nail of a screw fastener or a nailing machine (striking machine). When the striking machine is operated, the striking machine is started by engaging the contact member with a struck member and slidably operating the contact member. Further, the striking machine is stably positioned at a strike position of the struck member by making a claw formed at the contact member bite the struck member. According to the striking machine including both of the vertical guide and the contact member in this way, the contact member is formed in a ring-like shape to surround a front end portion of the vertical guide. Further, the contact member is arranged to be projected in the direction of the front end further from the front end of the vertical guide.

Further, in order to strike a nail or strike a screw to a metal piece or a reinforcement metal piece for building previously formed with a nail hole or a screw hole for striking the screw or the nail, or general wood or the like previously formed with a prepare hole for preventing wood splitting, there is needed a function of introducing a front end of the screw or the nail struck out from an injecting portion of a striking machine into the nail hole or the screw hole formed at the metal pieces or the prepared hole. JP-Y-06-030377 discloses a striking machine including a nail striking mechanism for propelling a nail supplied to a strike portion to project a front end of the nail from a front end of the strike portion prior to striking the nail, and nailing to fasten a metal piece for building or the like by inserting the front end of the nail projected from the strike portion by the nail striking mechanism and thereafter starting the striking machine.

According to the striking machine including both of the contact member and the vertical guide of the background arts, the vertical guide is attached to a nose portion formed with the strike portion. The contact member is supported slidably relative to the strike portion. The front end of the contact member is arranged to project in the direction of the front end further from the front end of the vertical guide. The front end portion of the contact member is formed in the ring-like shape to surround front end portions of pair of chuck members constituting the vertical guide. Therefore, the front end portion of the vertical guide is difficult to be optically viewed and it is difficult to position the striking machine to the prepared hole or the like previously formed at the struck member by the front end portion of the vertical guide. As a result, there is a case of bringing about a failure in striking since the screw or the nail cannot be struck into the holes.

The pair of chuck members forming the vertical guide are pivoted in a direction of opening the front end portions of the chuck members in passing a head portion of the screw or the nail having an expanded diameter. When an outer peripheral face of the front end portion of the chuck member is formed in a converging shape, and the front end is inserted into the prepared hole to be positioned thereby, the front end of the chuck member invades inside of the hole and opening in passing the head portion of the screw or the nail through the chuck member is restricted. As a result, when the head portion of the screw or the nail is seated on the struck member, there is a case in which the front end portion of the chuck member is entrapped into the hole, or the front end portion of the chuck member is destructed.

Further, according to the striking machine of the background art including the nail striking mechanism, in a case of use other than striking into the screw hole or the nail hole or the prepared hole, for example, normally striking to a flat face of a struck member which is not formed with a prepared hole, the front end of the screw or the nail projected from the strike portion is brought into contact with the face of the struck member, and it is difficult to position a striking machine stably to the struck member. Therefore, the striking machine cannot be used for such a use. As a result, it is necessary to respectively prepare exclusive striking machines.

### DISCLOSURE OF THE INVENTION

One or more embodiments of the invention provide a striking machine capable of easily positioning the striking machine to a normal flat face of a struck member and capable of firmly introducing a screw or a nail into a prepared hole previously formed at the struck member.

According to one or more embodiments of the invention, a striking machine is provided with a housing, a nose portion formed with a driver guide attached to a front end portion of the housing for slidably guiding a driver member, a contact member held by the nose portion, and a vertical guide including a pair of chuck members which are pivotably arranged opposedly by interposing a strike axis line and in which front end portions thereof are urged to pivot by elastic means in directions of being proximate to each other and arranged slidably along a direction of striking a screw or a nail relative to the nose portion. The vertical guide is elastically urged such that a front end portion of the vertical guide is normally projected to a side of a front end thereof further from a front end of the contact member.

Further, according to one or more embodiments of the invention, the housing may contain a driver member for striking out the screw or the nail and a drive mechanism for driving the driver member, the contact member may include an engaging claw directed in a direction of a front end thereof, the engaging claw may be able to engage with the struck member, and the vertical guide may guide the screw or the nail struck by the drive member along the strike axis line.

Further, according to one or more embodiments of the invention, the striking machine may further comprise a hold block held slidably along the direction of striking the screw relative to the nose portion. The contact member may be mounted to the hold block.

Further, according to one or more embodiments of the invention, the striking machine may be started by engaging the contact member with the struck member to be operated to slide relative to the nose portion and operating a trigger lever.

Further, according to one or more embodiments of the invention, the pair of chuck members may be slidably held by the hold block along the direction of striking the screw.

Further, according to one or more embodiments of the invention, the striking machine may further comprise a guide hole provided at the hold block and a chuck holder provided at the hold block. The pair of chuck members may be supported pivotably by the chuck holder, and the chuck holder may slidably be held by the hold block by loosely fitting a guide rod formed at the chuck holder with inside of the guide hole.

Further, according to one or more embodiments of the invention, a striking machine may be a screw fastener.

Further, according to one or more embodiments of the invention, the striking machine may be a nailing machine.

According to one or more embodiments of the invention, the vertical guide for guiding the screw or the nail struck by the driver member along the strike axis line is slidably arranged along the strike axis line relative to the nose portion, the vertical guide is elastically urged such that the front end portion of the vertical guide is projected to the side of the front end further from the front end of the contact member, and therefore, a prepared hole is facilitated to be aimed at by the front end of the chuck member formed with the vertical guide. For example, by forming the vertical guide by, for example, a converging cylindrical shape or the like, an accuracy of a position of striking the screw, the nail or the like or an accuracy of aiming at the hole in operating to aim at the prepared hole can be promoted and an increase in an efficiency of the operation can be achieved.

Further, the vertical guide is slidably arranged along the strike axis line relative to the nose portion, the nose portion is provided with the contact member formed with the engaging claw directed in the direction of the front end, and therefore, in a state of aiming at inside of the prepared hole by the chuck member of the vertical guide, by pressing the striking machine to the struck member to be operated thereby, the engaging claw of the contact member is engaged with the struck member, a strike position and a strike angle can be made to be stable and an operational efficiency can be promoted. Further, when the screw or the nail is struck to the struck member, the vertical guide can be slid further to the upper side, the vertical guide is not strongly pressed to the struck member by a press force operating to press the striking machine to the struck member, and the vertical guide can be prevented from being entrapped to inside of the prepared hole or the vertical guide can be prevented from being destructed. Further, since the front end of the vertical guide can be slid to the position of being drawn further from the front end of the contact member, and therefore, the striking machine mounted with the strike guide mechanism can be used for an operation of aiming at the hole and an operation of striking the flat face of the struck member, it is not necessary to interchange the striking machine or change a function by interchanging a part or by a changeover switch or the like, and the operational efficiency is not deteriorated.

Other aspects and advantages of the invention will be apparent from the following description and the appended claims.

### BRIEF DESCRIPTION OF THE DRAWINGS

FIG. 1 is a perspective view showing a screw fastener of the invention as an embodiment of a striking machine.

FIG. 2 is a rear view showing a nose portion of the screw faster of FIG. 1.

FIG. 3 is a plane view showing the nose portion of the screw fastener of FIG. 1.

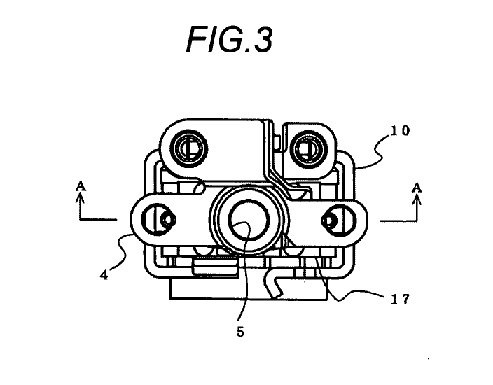

FIG. 4 is a perspective view showing a member constituting a strike guide mechanism of the screw fastener of FIG. 1.

FIG. 5 is a sectional view taken along a line A-A of FIG. 3.

FIG. 6 is a sectional view at a position the same as that of FIG. 5 in a state of sliding to move a vertical guide to an upper side.

FIG. 7 is a sectional view at a position the same as that of FIG. 5 in a state of finishing to strike a screw.

### DESCRIPTION OF REFERENCE NUMERALS AND SIGNS

1 screw fastener

4 nose portion

10 contact member

12 vertical guide

13 chuck member

14 chuck holder

19 spring

20 spring

21 guide face

22 front end portion

23 engaging claw

24 engaging claw

### BEST MODE FOR CARRYING OUT THE INVENTION

One or more embodiments of the invention will be explained in reference to the drawings as follows.

### Embodiment 1

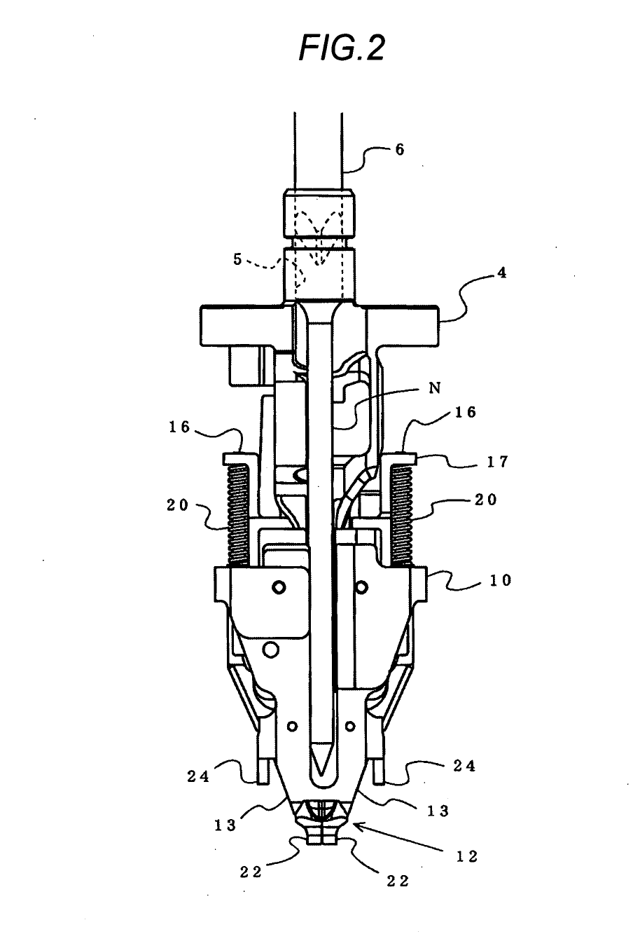

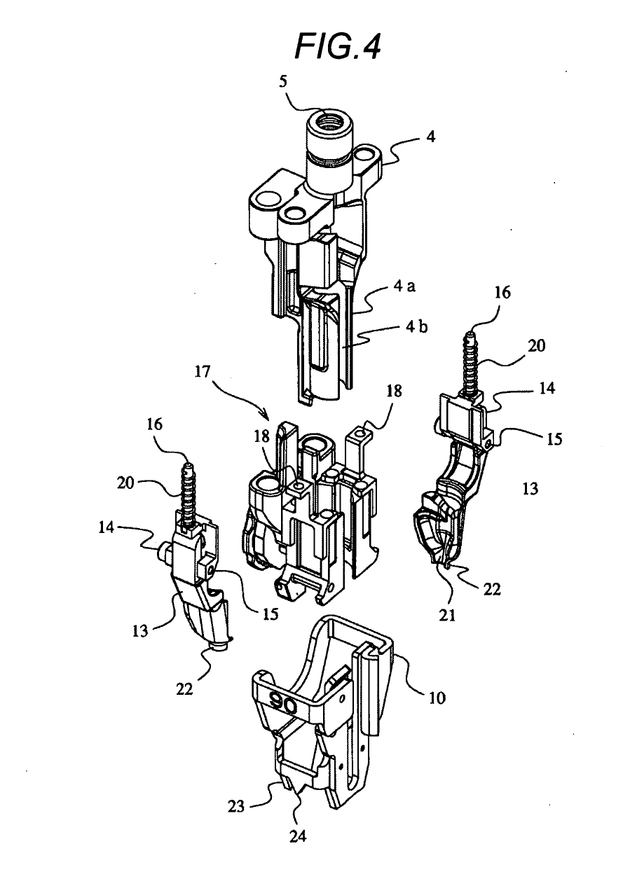

The drawings show a screw fastener operated by compressed air as an example of a striking machine of the invention, and a nose portion of the screw fastener. According to the screw fastener 1 according to the embodiment, inside of a housing 2 integrally formed with a grip portion 3 directed to a rear side contains a driver bit formed with an engaging portion engaged with a recess formed at a head portion of a screw, and a drive mechanism for driving to rotate the driver bit and propelling the driver bit in an axial direction. A lower side of a front end portion of the housing 2 is attached with a nose portion 4, as shown by FIG. 2, the driver bit 6 is contained at inside of a driver guide 5 formed on an upper side of the nose portion 4 to be guided thereby. Further, as shown by FIG. 4, a lower side of the driver guide 5 of the nose portion 4 is integrally formed with a cylindrical guide portion 4a for introducing to guide a screw to a struck member, a peripheral face of the cylindrical guide portion 4a directed to a rear side is formed with an opening 4b for introducing a screw to inside of the cylindrical guide portion 4a.

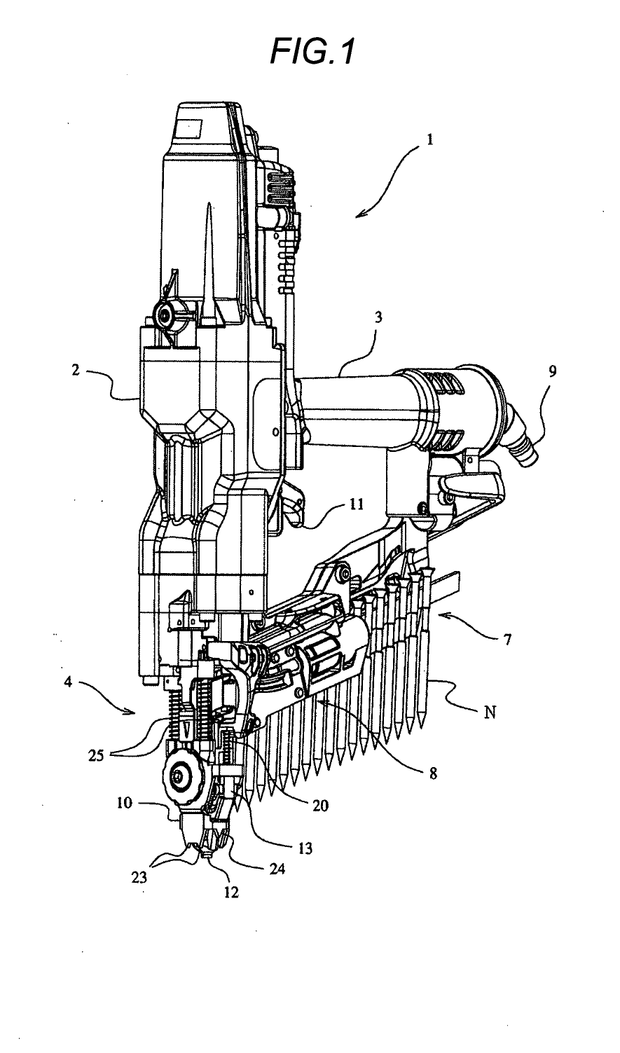

As shown by FIG. 1, a rear side of the nose portion 4 is continuously provided with a magazine portion 7 for charging connected screws constituted by connecting respective axis portions of a number of screws N to each other, front ones of the screws N of the connected screws are successively supplied to inside of the cylindrical guide portion 4a of the nose portion 3 by propelling the connected screws charged to the magazine portion 7 in a direction of the nose portion 4 by a supply mechanism 8 formed at the magazine portion 7. By driving the driver bit 6 by way of the drive mechanism by compressed air supplied to inside of the screw fastener 1 from an air plug 9 attached to a rear end of the grip portion 3, the screw is struck in a direction of the front end of the nose portion 4 while rotating the screw by engaging the front end portion of the driver bit 6 with the recess of the screw supplied to inside of the cylindrical guide portion 4a of the nose portion 4 and driving to propel the screw in the direction of the front end of the screw.

The cylindrical guide portion 4a of the nose portion 4 is attached with a hold block 17 slidably held by the nose portion 4 along a direction of striking the screw, and as shown by FIG. 1, the hold block 17 is urged to slide to be arranged normally in the direction of the front end of the nose portion 4 by a spring 25. Further, the hold block 17 is mounted with a contact member 10 brought into contact with the struck member in operating to strike the screw, in carrying out a screw fastening operation by the screw fastener 1, the screw fastener 1 is started by operating to slide the hold block 17 relative to the nose portion 4 by engaging the contact member 10 with the struck member by pressing the nose portion 4 to the struck member and operating a trigger lever 11 formed at a base portion of the grip portion 3.

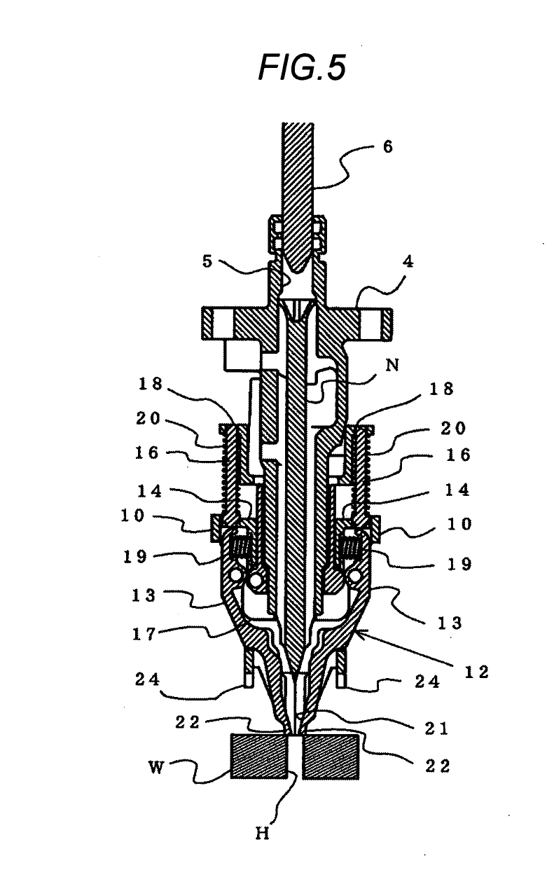

Further, the hold block 17 is formed with a vertical guide 12 for introducing a front end portion and an axis portion of the screw struck out in the direction of the front end of the nose portion 4 by the driver bit 6 along a strike axis line. As shown by FIG. 4 and FIG. 5, the vertical guide 12 is constituted by a pair of chuck members 13 pivotably supported by chuck holders 14 by axial support shafts 15, and the chuck holder 14 is held slidably relative to the hold block 17 by loosely fitting a guide rod 16 formed at the chuck holder 14 to inside of a guide hole 18 formed at the hold block 17. The pair of chuck members 13 are held slidably relative to the hold block 17 by way of the chuck holders 14.

As shown by FIG. 5, the pair of chuck members 13 are urged to pivot in a closing direction to make guide faces 21 formed at front end portions of the chuck members 13 proximate to each other by springs 19 arranged between the pair of chuck members 13 and the chuck holders 14, the axis portion of the screw N is guided to introduce along the strike axis line direction by engaging the front end portion and the axis portion of the screw N struck out in a state of engaging the driver bit 6 with the recess formed at the head portion of the screw N with the respective guide faces 21 of the pair of chuck members 13.

Further, the pair of chuck members 13 are urged to slide by springs 20 mounted to the guide rods 16 such that front end portions 22 of the chuck members 13 are arranged to project in a direction of screwing the screw, and when the screw fastener 1 is operated to press the struck member in accordance with an operation of striking the screw, the front end portions 22 of the chuck members 13 are brought into contact first with a face of the struck member. Further, an outer shape of the front end portions 22 of the respective chuck members 13 is formed in a shape of a cylinder an outer diameter of which is formed to be slender to facilitate to aim at a prepared hole previously formed at the struck member by the front end portions 22.

As shown by FIG. 4, the contact member 10 is formed in a shape of a square cylinder a center portion of which is hollowed, integrally attached to an outer side face of the hold block 17 to contain the hold block 17 at inside of the hollow portion, and the front end portions of the pair of chuck members 13 attached to the hold block 17 are made to be operated to open/close at inside of the hollow portion of the contact member 10 and slide along the direction of striking the screw. A front end of a front face of the contact member 10 is formed with two engaging claws 23 sharpened to be directed in the direction of striking the screw, and front ends of two side faces of the contact members 10 are formed with respective ones of engaging claws 24 sharpened to be directed in the striking direction.

According to the two engaging claws 23 formed at the front end of the front face of the contact member 10, when the screw fastener 1 strikes the screw orthogonally to the flat face of the struck member, in pressing the screw fastener 1 to the struck member, the two engaging claws 23 are brought into contact to be engaged with the face of the struck member W to stably position the screw fastener in an attitude orthogonal to the face of the struck member W. Further, according to the engaging claws 24 formed at the two side faces of the contact members 10, when the screw is fastened inclinedly to the face of the struck member, either one side of the engaging claws 24 is made to bite the face of the struck member to stably position the screw fastener 1 in a state of being inclined to the face of the struck member W.

An explanation will be given of operation of a strike guide mechanism by the screw fastener 1 according to the embodiment. Before operating the screw fastener 1, as shown by FIG. 5, the hold member 17 for holding the contact member 10 and the vertical guide 12 is arranged to be pressed in the direction of the front end relative to the nose portion 4 by the springs 25, and according to the pair of chuck members 23 pivoted by the springs 19 in a state of closing the front end portions, the front end portions 22 of the chuck members 13 are arranged at positions projected in the directions of the front ends further from the engaging claws 23 formed at the front end of the contact member 10 by operating the springs 20. When the front end of the nose portion 4 of the screw fastener 1 is pressed to the struck face of the struck member W under the state, the front end portions 22 of the pair of chuck members 13 are brought into contact with the face of the struck member, and therefore, the screw fastener 1 can accurately be positioned relative to a prepared hole in a state of attaching the front end portions 22 of the pair of chuck members 13 formed in the shape of the cylinder to the prepared hole H previously formed at the struck member W.

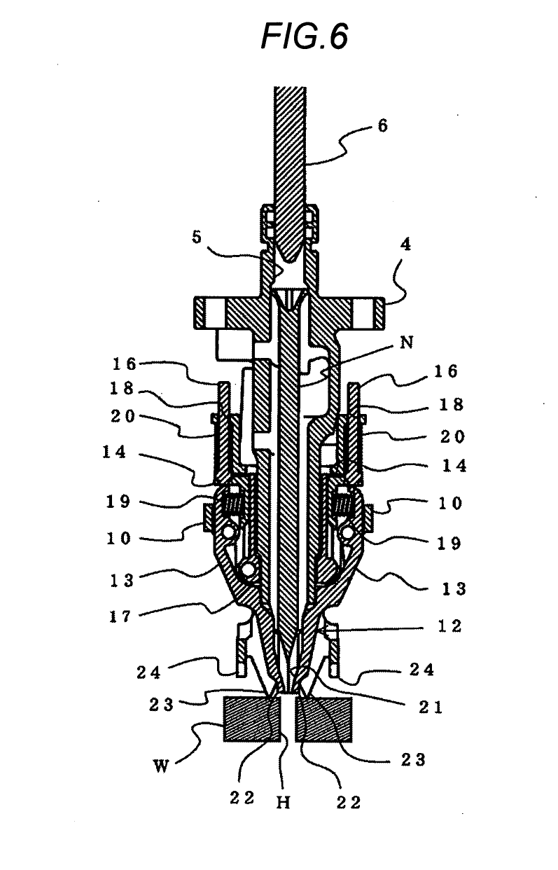

Thereafter, when the nose portion 4 of the screw fastener 1 is pressed to the struck member W in the state of attaching the front ends of the chuck members 13 to the hole, as shown by FIG. 6, the pair of vertical guides 13 are moved back to an upper side of the nose portion 4 against elastic forces of the springs 20 by being pressed to the struck member W, the hold member 17 mounted to the cylindrical guide portions 4a of the nose portion 4 is propelled to the struck member W along with the nose portion 4, and the two engaging claws 23 formed at the front end of the contact member 10 mounted to the hold member 17 are engaged with the struck member. The front ends of the two engaging claws 23 bite the face of the struck member and the screw fastener 1 is positioned relative to the struck member by the engaging claws.

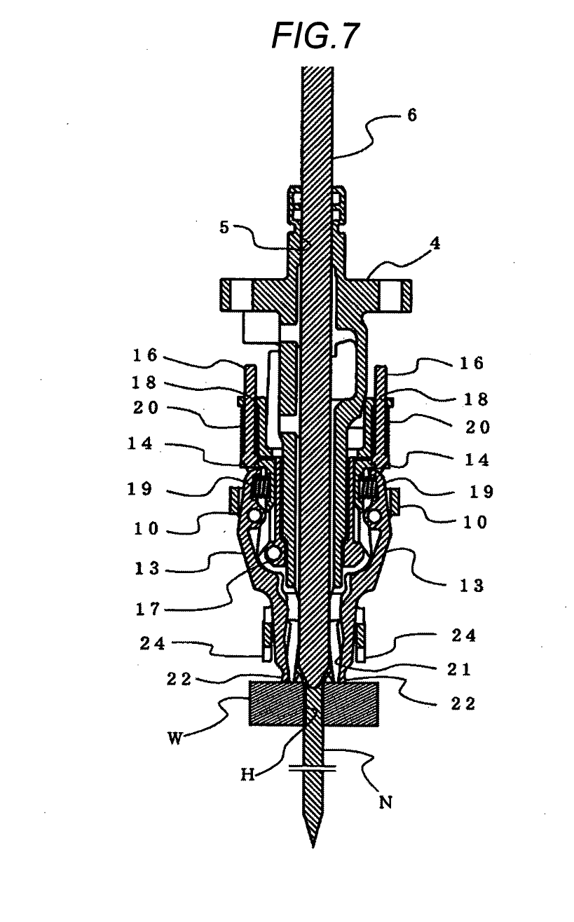

Further, when the nose portion 4 of the screw fastener 1 is pressed to the face of the struck member, the hold member 17 holding the contact member is operated to an upper side relative to the nose portion 4, further, when the trigger lever 11 is operated by the hand grasping the grip portion 3, the screw fastener 1 is started. When the screw fastener 1 is started, as shown by FIG. 7, the driver bit 6 is engaged with the head portion of the screw supplied to inside of the cylindrical guide portion 4a to rotate the screw and propel the screw in the direction of the front end to thereby screw the screw to the struck member W. The screwed screw is introduced to be guided onto the striking axis line by the vertical guide 12 constituted by the pair of chuck members 13 urged to pivot in the closing direction, and therefore, the screw is accurately introduced into the prepared hole H of the struck member W to be screwed. In this way, after aiming at the position of the prepared hole by the front end of the chuck member 13, the engaging claw of the contact member is engaged with the struck member to position the screw fastener 1, and therefore, an operation of fastening the screw into the prepared hole can accurately and stably be carried out.

When the head portion of the screw passes through the guide faces 21 of the pair of chuck members 13, the guide faces 21 of the chuck members 13 are pressed by the head portion of the screw to operate to pivot the chuck members 13 in an opening direction, however, the chuck members 13 are not operated with an operating force for operating to press the screw fastener 1 to the struck member, and therefore, the front ends of the chuck members 13 are not restricted from moving in the opening direction by being pressed by the struck member, and the front end portions 22 can be pivoted in the opening direction by moving the respective chuck members 13 respectively to the upper side against press forces of the springs 20. Therefore, when the screw is screwed into the prepared hole, the front end portion of the chuck member 13 can be prevented from being entrapped into the prepared hole, further, even when a wall thickness of the front end portion of the chuck member is formed to be thin, the front end portion is not destructed, and therefore, the diameter of the front end portion in the cylindrical shape can further slenderly be formed and an accuracy of aiming at the prepared hole can be promoted.

Further, although an explanation has been given of the screw fastener as an example of a striking machine according to the above-described embodiment, the embodiment can similarly be applied to a nailing machine.

Although an explanation has been given of the invention in details and in reference to the specific embodiment, it is apparent for the skilled person that the invention can variously be changed or modified without deviating from the spirit and the range of the invention.

The application is based on Japanese Patent Application (Patent Application No. 2004-341603) filed on Nov. 26, 2004, and contents of which are hereby incorporated by reference.

### INDUSTRIAL APPLICABILITY

According to the striking machine of one or more embodiments of the invention, the striking machine of a screw, a nail or the like can be positioned to the normal flat face of the struck member, further, can firmly introduce a screw, a nail or the like also into the prepared hole previously formed to the struck member.

1. A striking machine comprising:
a housing;
a nose portion attached to a front end portion of the housing and forming a driver guide for slidably guiding a driver member;
a contact member held by the nose portion; and
a vertical guide including a pair of chuck members, wherein the pair of chuck members are opposed by interposing a strike axis line and pivotably arranged and urged to pivot by elastic means in directions so that front end portions of the pair of chuck members are proximate to each other, and the vertical guide is arranged slidably along a direction of striking a screw or a nail relative to the nose portion;
wherein the vertical guide is elastically urged so that a front end portion of the vertical guide is projected to a front end side further from a front end of the contact member in a normal state.

2. The striking machine according to claim 1, wherein the housing contains a driver member for striking out the screw or the nail and a drive mechanism for driving the driver member;
the contact member includes an engaging claw directing in a direction of a front end of the contact member;
the engaging claw is capable of being engaged with a struck member; and
the vertical guide guides the screw or the nail struck by the drive member along the strike axis line.

3. The striking machine according to claim 1, further comprising:
a hold block slidably held relative to the nose portion along the direction of striking the screw;
wherein the contact member is mounted on the hold block.

4. The striking machine according to claim 3, wherein the striking machine is started by engaging the contact member with the struck member to be operated to slide relative to the nose portion and operating a trigger lever.

5. The striking machine according to claim 3, wherein the pair of chuck members are slidably held by the hold block along the direction of striking the screw.

6. The striking machine according to claim 5, further comprising:
a guide hole provided at the hold block; and
a chuck holder provided at the hold block;
wherein the pair of chuck members are pivotably supported by the chuck holder; and
the chuck holder is slidably held relative to the hold block by loosely fitting a guide rod formed at the chuck holder to inside of the guide hole.
